(19) United States
(12) Patent Application Publication
(10) Pub. No.: US 2026/0285382 A1
(43) Pub. Date: Sep. 24, 2026

(54) TIPPING APPARATUS FOR A WHEELBARROW

(71) Applicant: ITIP HANDLES LIMITED, Wokingham (GB)

(72) Inventor: Simon ALLDER, Wokingham (GB)

(73) Assignee: ITIP HANDLES LIMITED, Wokingham (GB)

(21) Appl. No.: 19/478,190

(22) PCT Filed: Apr. 8, 2024
(86) PCT No.: PCT/GB2024/050933

§ 371 Date: Oct. 23, 2025

(30) Foreign Application Priority Data
Apr. 23, 2023 (GB) 2305932.2
Dec. 11, 2023 (GB) 2318855.0

(51) Int. Cl. B62B 1/22; B62B 5/06

(52) U.S. Cl. CPC B62B 1/22; B62B 5/061

(57) ABSTRACT

A wheelbarrow comprising a frame forming at one end a pair of handles and at the other end a fork between which is located a front wheel. The wheelbarrow has a first pair of grip units connected to the pair of handles respectively, and a second pair of grip units connected to the outside of the fork arms respectively, either side of the wheel.

### FIELD OF INVENTION

This invention relates to tipping apparatus for a wheelbarrow. More especially, the invention relates to hand grips locatable on the wheelbarrow frame, either side of the front wheel, which extend parallel to wheel frame to allow tipping of the wheelbarrow about its lateral axis to empty the contents within the wheelbarrow hopper.

### BACKGROUND TO THE INVENTION

Normal use of a traditional wheelbarrow (pushing the wheelbarrow along the ground) involves each hand of a user being placed with the palm facing inwards and the fingers curling under the handle. To tip the contents of the barrow out over the front wheel, the barrow is raised to a roughly vertical position about its longitudinal axis. To hold the barrow in that position, the hands are rotated so that the fingers are curled over the tops of the handles (with the palms remaining on the outsides of the handles). This requires a change-over of the grasp, with the palms and the balls of the thumbs supporting the weight of the barrow during the change-over. There is a risk that the user may lose control of the barrow during this process, with the barrow and/or its contents falling into undesired, awkward, or dangerous positions. There is also a risk that the user may injure their hand as a result.

Handles for a wheelbarrow which allow easier control during forward tipping have been developed in association with the applicant. Such handles are disclosed in EP1819572. In that patent, the simple handles are modified by the addition of grip units which allow the user to raise the barrow without having to perform such a change of grasp. In use, the user grasps the holding bars of the grip units. To raise the barrow, the user has to raise the grip units, but maintains the same grasp, with the holding bars rotating to remain generally horizontal as the barrow is raised and the handle shafts rotate from roughly horizontal towards the vertical.

Whilst the grip units of the have proved to be commercially successful, the hand grips provided only on the handles or handle shafts of the wheelbarrow only address previous difficulties in raising the wheelbarrow about its longitudinal axis, to provide stability of the wheelbarrow during vertical tipping.

There are many occasions in which lateral tipping of the wheelbarrow is preferable, for example when the amount of contents being moved causes it to fall in mounds or heaps which restrict the ability of the wheelbarrow to tip its fullest extent vertically in order empty the hopper entirely of its contents.

Tipping a wheelbarrow laterally can be extremely awkward, particularly with a single user. Often the wheelbarrow will tip suddenly and entirely onto its side providing a complete lack of control and often making it difficult to turn the wheelbarrow back upright, especially when the side rim of the hopper engages the ground and is covered by the contents half spilled from the hopper.

To avoid this, a second user may often attempt to laterally tip the front of the wheelbarrow at the same time, but the lack of grip areas can pose a danger to the fingers of the second user if they slip into the front wheel frame during the largely uncontrolled tipping process. Further, the front wheel frame of the wheelbarrow is often clogged with mud, dirt and other debris making any grip difficult and extremely messy.

The present invention seeks to alleviate the above-mentioned problems of lateral wheelbarrow tipping by providing grip units extending from the handle shafts and extending from either side of the front wheel frame.

### Statements of Invention

According to a first aspect, there is provided, a wheelbarrow comprising a frame forming at one end a pair of handles and at the other end a fork between which is located a front wheel, the wheelbarrow further comprising: a first pair of grip units connected to the pair of handles respectively, and a second pair of grip units connected to the outside of the fork arms respectively, either side of the wheel.

To this end, one gripping unit is secured to each handle and each fork of the wheelbarrow frame.

Preferably, the second pair of grip units are secured to the outside of each fork arm.

Preferably, the first pair of grip units are secured to the outside of each handle.

Preferably, each grip unit comprises a holding bar connected to a shaft via a bearing.

Preferably, the shaft is secured to the wheelbarrow frame to extend perpendicularly therefrom. Preferably, the holding bar of each grip unit, when secured, extends generally parallel to the longitudinal axis of the wheelbarrow.

Preferably, each holding bar is rotatable about the shaft to maintain a generally horizontal orientation when the wheelbarrow is tipped.

### BRIEF DESCRIPTION OF DRAWINGS

At least one embodiment of the invention will now be described with reference to the accompanying figures in which:

FIG. 1 shows a side perspective view of wheelbarrow with tippable apparatus constructed in accordance with the invention;

FIG. 2 shows an exploded view of a gripping unit forming part of the invention;

FIG. 3 shows a detailed side view of the front wheel frame of the wheelbarrow of FIG. 1; and

FIG. 4 shows a top perspective view of the wheelbarrow of FIGS. 1 and 2.

### DETAILED DESCRIPTION OF THE INVENTION

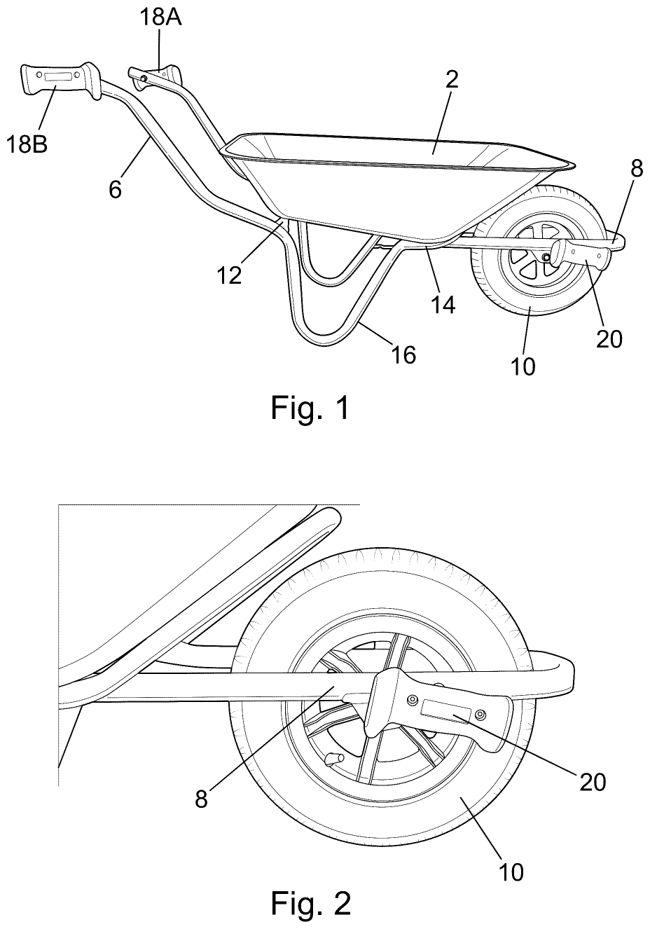

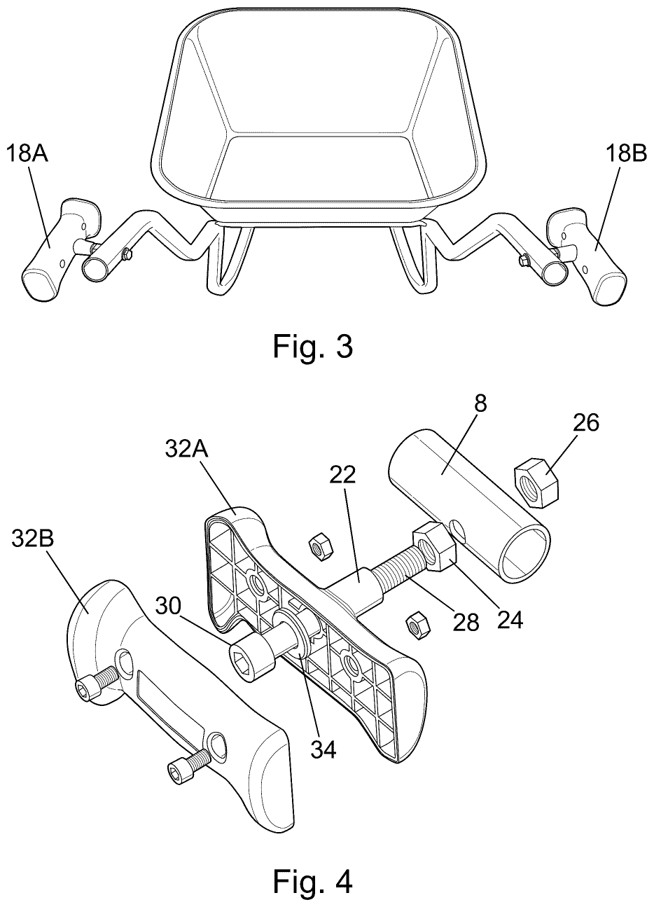

As can be seen in FIG. 1, the invention comprises a wheelbarrow in conventional form, having a hopper 2 mounted on a tubular frame 4. The frame 4 is shaped to form at one end a pair of handles 6 and a the other a front fork 8 in which a front wheel 10 is mounted.

In between both ends, the frame is shaped to provide front and back supports, 12, 14 for the hopper 2 and feet 16 in between.

In the present invention, the simple handles 6 are modified by the addition of grip units which allow the user to raise the barrow without having to perform such a change of grasp.

A first pair of grip units 18 are secured to the wheelbarrow handles 6. The grip units 18 may take the structure and form of those described in EP1819572.

FIG. 2 shows the arrangement of the handle in detail. The handle comprises a shaft 22 held onto the respective handle 6 by two nuts 24 and 26, nut 24 being turned on the shaft 22 until it reaches the end of a threaded portion 28. A bearing is formed by a simple head 30 on the end of the shaft 22 fitting in a socket in first half 32A of a holding bar, together with the end of a smooth part of the shaft 22 engaging in a hole in the holding bar half 32A. A washer 34 is positioned over the shaft 22 against the head 30 as shown. The first holding bar half 32A is then bolted to the second hold bar half 32B by bolts and nuts.

In use, the user grasps the holding bars of the grip units. To raise the barrow, the user has to raise the grip units, but maintains the same grasp, with the holding bars rotating to remain generally horizontal as the barrow is raised and the handle shafts 22 rotate from roughly horizontal towards the vertical.

Two assist lateral tipping, a second pair of grip units 20 are secured to the wheelbarrow frame 4, with arm grip unit 20 secured to each arm of front fork 8 such that a grip unit 18 is provided outside the frame either side of the front wheel 10.

Providing grip units 18, 20 at both ends of the wheelbarrow, at the handles 6 and the front wheel 10, allow two users to tip wheelbarrow in respect of its lateral axis in unison and in a controlled manner using the grips 18, 20.

As both sides of the wheelbarrow are supported by the user's hands during lateral tipping, the angle of the wheelbarrow can be controlled. Further, the hopper 2 can remain raised off the ground during tipping to empty all the contents of the hopper 2 without covering the hopper edge and holding it against the floor preventing it from being easily uprighted.

Moreover, the fact that the front grip units 20 extend generally parallel to the longitudinal axis of the wheelbarrow allows both grips 20 to be comfortably held by a user standing at the front of the wheelbarrow.

1. A wheelbarrow comprising a frame forming at one end a pair of handles and at the other end a fork between which is located a front wheel, the wheelbarrow further comprising:
a first pair of grip units connected to the pair of handles respectively, and
a second pair of grip units connected to the outside of the fork arms respectively, either side of the wheel.

2. A wheelbarrow according to claim 1, wherein the second pair of grip units are secured to the outside of each fork arm.

3. A wheelbarrow according to claim 2, wherein the first pair of grip units are secured to the outside of each handle.

4. A wheelbarrow according to claim 1, wherein each grip unit comprises a holding bar connected to a shaft via a bearing.

5. A wheelbarrow according to claim 4, wherein the shaft is secured to the wheelbarrow frame to extend perpendicularly therefrom.

6. A wheelbarrow according to claim 5, wherein the holding bar of each grip unit, when secured, extends generally parallel to the longitudinal axis of the wheelbarrow.

7. A wheelbarrow according to claim 6, wherein each holding bar is rotatable about the shaft to maintain a generally horizontal orientation when the wheelbarrow is tipped.
